(19) United States
(12) Patent Application Publication
(10) Pub. No.: US 2021/0373187 A1
(43) Pub. Date: Dec. 2, 2021

(54) FOCUS-STACKING IMAGING METHOD AND SYSTEM BASED ON CORRELATION-BASED SEISMIC INTERFEROMETRY

(71) Applicant: Beijing Research Institute of Uranium Geology, Beijing (CN)

(72) Inventors: Baoping QIAO, Beijing (CN); Yichan WANG, Beijing (CN); Chengyin CAO, Beijing (CN); Ziqiang PAN, Beijing (CN); Weichuan HUANG, Beijing (CN); Yucheng HUANG, Beijing (CN); Qiao WANG, Beijing (CN)

(21) Appl. No.: 16/992,910

(22) Filed: Aug. 13, 2020

(30) Foreign Application Priority Data
May 29, 2020 (CN) 202010473317.2

(51) Int. Cl. G01V 1/30

(52) U.S. Cl. CPC G01V 1/306; G01V 1/303; G01V 2210/64; G01V 2210/6222; G01V 2210/32

(57) ABSTRACT

The present invention discloses a focus-stacking imaging method and system based on correlation-based seismic interferometry. The method includes: loading an acquisition system to a seismic data set, picking up seismic first arrival traveltimes recorded by all shot gathers, and then performing refraction tomographic static correction, noise suppression, energy compensation, and deconvolution; processing the seismic data set after deconvolution by using an iterative residual static correction method and a high-accuracy velocity analysis method, to obtain a migration velocity model and a seismic data set after residual static correction; determining a common reflection point gather after muting and zero-offset gathers at different reflection points; calculating an amount of move-out correction for each common reflection point gather and a common reflection point gather after interferometric normal move-out correction; performing focus-stacking on the common reflection point gather after interferometric normal move-out correction, to obtain imaging results at different reflection points.

### TECHNICAL FIELD

The present invention relates to the technical field of land or ocean seismic exploration, and in particular, to a focus-stacking imaging method and system based on correlation-based seismic interferometry.

### BACKGROUND

As seismic exploration goes further, the exploration also faces more challenges. To obtain fine tectonic characteristics and physical property parameters of deep complex formations, high-precision exploration in shallow formations first needs to be ensured. Due to strong heterogeneity, significant anisotropy, relatively large velocity gradients, and complex near-surface conditions of the shallow formations, shallow seismic data tends to be of poor quality. In addition, due to a relatively low fold and severe interference of near-surface noises such as surface waves and acoustic waves, shallow seismic data has a relatively low signal-to-noise ratio. Meanwhile, the conventional stacking method based on muting and stretching further reduces the fold and signal-to-noise ratio of effective data about shallow seismic reflected waves, and increases difficulty of depth imaging and physical property inversion. Therefore, the conventional imaging method based on a velocity model cannot effectively use shallow seismic data and cannot achieve fine exploration of the shallow formations, which consequently limits the extraction of deep complex tectonics and physical property information, and reduces the overall effects of seismic exploration.

### SUMMARY

On this basis, it is necessary to provide a focus-stacking imaging method and system based on correlation-based seismic interferometry, to increase a signal-to-noise ratio and resolution of shallow seismic data, thereby implementing fine exploration of shallow complex formations.

To achieve the above purpose, the present invention provides the following technical solutions:

A focus-stacking imaging method based on correlation-based seismic interferometry includes:

obtaining a seismic data set;

loading an acquisition system to the seismic data set, to obtain a seismic data set including acquisition system information;

picking up, by using the seismic data set including the acquisition system information, seismic first arrival traveltimes recorded by all shot gathers, and sequentially performing refraction tomographic static correction based on the seismic first arrival traveltimes, noise suppression, energy compensation, and deconvolution, to obtain a seismic data set after deconvolution;

processing the seismic data set after deconvolution by using an iterative residual static correction method and a high-accuracy velocity analysis method, to obtain a migration velocity model and a seismic data set after residual static correction;

performing, based on the migration velocity model by using a Kirchhoff pre-stack migration method, migration and stacking processing on the seismic data set after the residual static correction, to obtain a migrated common reflection point gather and a stacked imaging data set based on stretching and muting;

processing the migrated common reflection point gather sequentially by using a processing method of inverse normal move-out correction and a manual muting method based on the migration velocity model, to obtain a common reflection point gather after muting;

intercepting, by using a window function having a specified wave length, seismic data including shallow information on shallow target in the stacked imaging data set based on stretching and muting, to obtain zero-offset gathers at different reflection points;

calculating cross-correlation between a seismic trace at different offset and a corresponding zero-offset seismic trace in the common reflection point gather after muting, to obtain an amount of move-out correction for each common reflection point gather;

calculating cross-correlation between a seismic trace at different offset in the common reflection point gather after muting and the corresponding amount of move-out correction, to obtain a common reflection point gather after interferometric normal move-out correction; and

performing focus-stacking on the common reflection point gather after interferometric normal move-out correction, to obtain imaging results at different reflection points.

Optionally, the picking up, by using the seismic data set including the acquisition system information, seismic first arrival traveltimes recorded by all shot gathers, and sequentially performing refraction tomographic static correction based on the seismic first arrival traveltimes, noise suppression, energy compensation, and deconvolution, to obtain a seismic data set after deconvolution specifically includes:

picking up, by using the seismic data set including the acquisition system information, seismic first arrival traveltimes recorded by all shot gathers, and obtaining, by using a refraction tomographic static correction method, a seismic data set after refraction tomographic static correction;

performing noise suppression on the seismic data set after refraction tomographic static correction, to obtain a suppressed seismic data set;

performing, by using a surface-consistent amplitude compensation method, energy compensation on the seismic data set after noise suppression, to obtain a seismic data set after compensation; and

deconvoluting the compensated seismic data set by using a combination of predictive deconvolution method and surface-consistent deconvolution method, to obtain a seismic data set after deconvolution.

Optionally, the processing the migrated common reflection point gather sequentially by using a processing method of inverse normal move-out correction and a manual muting method based on the migration velocity model, to obtain a common reflection point gather after mutting specifically includes:

processing the migrated common reflection point gather by using the processing method of inverse normal move-out correction based on the migration velocity model, to obtain a common reflection point gather after inverse normal move-out correction; and

manually muting direct waves and refracted waves on the common reflection point gather after inverse normal move-out correction, to obtain the common reflection point gather after muting.

Optionally, the obtaining a seismic data set specifically includes:

obtaining raw seismic data; and

deleting an abnormal data set in the raw seismic data, to obtain the seismic data set, where the abnormal data set includes the dead shots, environmental noise shots, and seismic data with dead traces.

Optionally, the performing noise suppression on the seismic data set after refraction tomographic static correction, to obtain a suppressed seismic data set specifically includes:

suppressing, sequentially by using an adaptive surface wave attenuation method, a linear correlation method, and an anomalous amplitude attenuation method, noise of the seismic data set after refraction tomographic static correction, to obtain a seismic data set after noise suppression.

The present invention further provides a focus-stacking imaging system based on correlation-based seismic interferometry, including:

a data obtaining module, configured to obtain a seismic data set;

a first determining module, configured to load an acquisition system to the seismic data set, to obtain a seismic data set including acquisition system information;

a second determining module, configured to pick up, by using the seismic data set including the acquisition system information, seismic first arrival traveltimes recorded by all shot gathers, and sequentially perform refraction tomographic static correction based on the seismic first arrival traveltimes, noise suppression, energy compensation, and deconvolution, to obtain a seismic data set after deconvolution;

a third determining module, configured to process the seismic data set after deconvolution by using an iterative residual static correction method and a high-accuracy velocity analysis method, to obtain a migration velocity model and a seismic data set after residual static correction;

a fourth determining module, configured to perform, based on the migration velocity model by using a Kirchhoff pre-stack migration method, migration and stacking processing on the seismic data set after the residual static correction, to obtain a migrated common reflection point gather and a stacked imaging data set based on stretching and muting;

a fifth determining module, configured to process the migrated common reflection point gather sequentially by using a processing method of inverse normal move-out correction and a manual muting method based on the migration velocity model, to obtain a common reflection point gather after muting;

a sixth determining module, configured to intercept, by using a window function having a specified wave length, seismic data including formation information on shallow target in the stacked imaging data set based on stretching and muting, to obtain zero-offset gathers at different reflection points;

a first calculation module, configured to calculate cross-correlation between a seismic trace at different offset and a corresponding zero-offset seismic trace in the common reflection point gather after muting, to obtain an amount of move-out correction for each common reflection point gather;

a second calculation module, configured to calculate cross-correlation between a seismic trace at different offset in the common reflection point gather after muting and the corresponding amount of move-out correction, to obtain a common reflection point gather after interferometric normal move-out; and

an imaging module, configured to perform focus-stacking on the common reflection point gather after interferometric normal move-out, to obtain imaging results at different reflection points.

Optionally, the second determining module specifically includes:

a first determining unit, configured to pick up, by using the seismic data set including the acquisition system information, seismic first arrival traveltimes recorded by all shot gathers, and obtain, by using a refraction tomographic static correction method, a seismic data set on which refraction tomographic static correction is performed;

a second determining unit, configured to perform noise suppression on the seismic data set on which refraction tomographic static correction is performed, to obtain a noise suppressed seismic data set;

a third determining unit, configured to perform, by using a surface-consistent amplitude compensation method, energy compensation on the seismic data set on which noise suppression is performed, to obtain a compensated seismic data set; and

a fourth determining unit, configured to deconvolute the compensated seismic data set by using a combination of predictive deconvolution method and surface-consistent deconvolution method, to obtain a seismic data set after deconvolution.

Optionally, the fifth determining module specifically includes:

a fifth determining unit, configured to process the migrated common reflection point gather by using a processing method of inverse normal move-out correction based on the migration velocity model, to obtain a common reflection point gather after inverse normal move-out correction; and

a sixth determining unit, configured to manually mute direct waves and refracted waves on the common reflection point gather after inverse normal move-out, to obtain the common reflection point gather after muting.

Optionally, the data obtaining module specifically includes:

a raw data obtaining unit, configured to obtain raw seismic data; and

an abnormal data deletion unit, configured to delete an abnormal data set in the raw seismic data, to obtain the seismic data set, where the abnormal data set includes bad shots, environmental noise shots, and seismic data with dead traces.

Optionally, the second determining module specifically includes:

a noise suppression subunit, configured to suppress, sequentially by using an adaptive surface wave attenuation method, a linear correlation method, and an anomalous amplitude attenuation method, noise of the seismic data set after refraction tomographic static correction, to obtain a seismic data set after noise suppression.

Compared with the prior art, the present invention has the following beneficial effects:

The present invention provides a focus-stacking imaging method and system based on correlation-based seismic interferometry. On the basis of conventional seismic data processing, in combination with correlation of seismic reflection events, effective extraction and focus-stacking imaging are implemented on seismic reflection events with a high signal-to-noise ratio and high resolution by using a correlation-based seismic interferometry. Based on the method or system of the present invention, a signal-to-noise ratio and resolution of shallow seismic data can be increased, thereby implementing fine exploration of shallow complex formations.

### BRIEF DESCRIPTION OF THE DRAWINGS

To describe the technical solutions in the examples of the present invention or in the prior art more clearly, the following briefly describes the accompanying drawings required for describing the examples. Apparently, the accompanying drawings in the following description show merely some examples of the present invention, and a person of ordinary skill in the art may still derive other drawings from these accompanying drawings without creative efforts.

FIG. 1 is a flowchart of a focus-stacking imaging method based on correlation-based seismic interferometry according to Example 1 of the present invention;

FIG. 2 is a schematic diagram of a common reflection point gather obtained after processing performed according to step 1 to step 10 in Example 2 of the present invention;

FIG. 3 is a schematic diagram of amount of move-out correction of different seismic traces in a common reflection point gather obtained according to step 12 in Example 2 of the present invention;

FIG. 4 is a schematic diagram of a common reflection point gather after a normal move-out correction according to step 13 in Example 2 of the present invention;

FIG. 5 is a schematic diagram of a focus-stacking imaging result in Example 2 of the present invention; and

FIG. 6 is a schematic structural diagram of a focus-stacking imaging system based on correlation-based seismic interferometry according to Example 3 of the present invention.

FIG. 7 is block diagram of an exemplary system capable of performing the methods disclosed herein.

### DETAILED DESCRIPTION

The following clearly and completely describes the technical solutions in the examples of the present invention with reference to accompanying drawings in the examples of the present invention. Apparently, the described examples are merely a part rather than all of the examples of the present invention. All other examples obtained by a person of ordinary skill in the art based on the examples of the present invention without creative efforts shall fall within the protection scope of the present invention.

To make the objectives, features and advantages of the present invention more apparent and comprehensible, the present invention is described in more detail below with reference to the accompanying drawings and specific implementations.

### Example 1

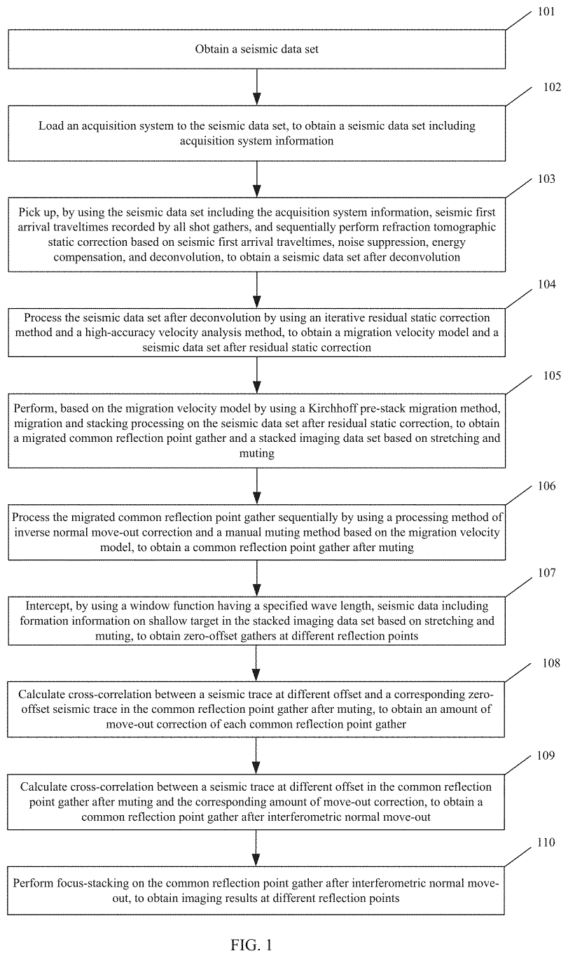

FIG. 1 is a flowchart of a focus-stacking imaging method based on correlation-based seismic interferometry according to Example 1 of the present invention.

Referring to FIG. 1, a focus-stacking imaging method based on correlation-based seismic interferometry in this example includes the following steps.

Step 101: obtain a seismic data set.

Step 102: load an acquisition system to the seismic data set, to obtain a seismic data set including acquisition system information.

Step 103: pick up, by using the seismic data set including the acquisition system information, seismic first arrival traveltimes recorded by all shot gathers, and sequentially perform refraction tomographic static correction based on seismic first arrival traveltimes, noise suppression, energy compensation, and deconvolution, to obtain a seismic data set after deconvolution.

Step 104: process the seismic data set after deconvolution by using an iterative residual static correction method and a high-accuracy velocity analysis method, to obtain a migration velocity model and a seismic data set after residual static correction.

Step 105: perform, based on the migration velocity model by using a Kirchhoff pre-stack migration method, migration and stacking processing on the seismic data set after residual static correction, to obtain a migrated common reflection point gather and a stacked imaging data set based on stretching and muting.

Step 106: process the migrated common reflection point gather sequentially by using a processing method of inverse normal move-out correction and a manual muting method based on the migration velocity model, to obtain a common reflection point gather after muting.

Step 107: intercept, by using a window function having a specified wave length, seismic data including formation information on shallow target in the stacked imaging data set based on stretching and muting, to obtain zero-offset gathers at different reflection points.

Step 108: calculate cross-correlation between a seismic trace at different offset and a corresponding zero-offset seismic trace in the common reflection point gather after muting, to obtain an amount of move-out correction of each common reflection point gather.

Step 109: calculate cross-correlation between a seismic trace at different offset in the common reflection point gather after muting and the corresponding amount of move-out correction, to obtain a common reflection point gather after interferometric normal move-out.

Step 110: perform focus-stacking on the common reflection point gather after interferometric normal move-out, to obtain imaging results at different reflection points.

Step 103 specifically includes:

(1) picking up, by using the seismic data set including the acquisition system information, seismic first arrival traveltimes recorded by all shot gathers, and obtaining, by using a refraction tomographic static correction method, a seismic data set after refraction tomographic static correction; and

(2) performing noise suppression on the seismic data set after refraction tomographic static correction, to obtain a suppressed seismic data set, where specifically, noise of the seismic data set after refraction tomographic static correction is suppressed sequentially by using an adaptive surface wave attenuation method, a linear correlation method, and an anomalous amplitude attenuation method, to obtain a seismic data set after noise suppression;

(3) performing, by using a surface-consistent amplitude compensation method, energy compensation on the seismic data set after noise suppression, to obtain a compensated seismic data set; and

(4) deconvoluting the compensated seismic data set by using a combination of predictive deconvolution method and surface-consistent deconvolution method, to obtain a seismic data set after deconvolution.

Step 106 specifically includes:

(1) processing the migrated common reflection point gather sequentially by using a processing method of inverse normal move-out correction based on the migration velocity model, to obtain a common reflection point gather after inverse normal move-out; and

(2) manually muting direct waves and refracted waves on the common reflection point gather after inverse normal move-out correction, to obtain the common reflection point gather after muting.

Step 101 specifically includes:

(1) obtaining raw seismic data; and

(2) deleting an abnormal data set in the raw seismic data, to obtain the seismic data set, where the abnormal data set includes bad shots, environmental noise shots, and seismic data with dead traces.

The following provides a more specific example.

### Example 2

A specific procedure of the focus-stacking imaging method based on correlation-based seismic interferometry provided in this example is as follows:

Step 1. check raw seismic data, and deleting an abnormal data set such as a bad shot, an environmental noise shot, and a seismic data with dead traces based on an energy difference and an amplitude difference, to obtain a normal seismic data set.

Step 2. load acquisition system information by using the normal seismic data set obtained in step 1 and an SPS file, calculate and check attribute information of a generated surface element, and obtain a seismic data set including the acquisition system information.

Step 3. pick up, by using the seismic data set that includes the acquisition system information and that is generated in step 2, seismic first arrival traveltimes recorded by all shot gathers. On this basis, a seismic static correction value is obtained and loaded by using a refraction tomographic static correction method, and a seismic data set after refraction tomographic static correction is obtained.

Step 4. based on the seismic data set after refraction tomographic static correction, suppress a frequency-disperse surface wave by using an adaptive surface wave attenuation method, suppress linear noise by using a linear correlation method, and suppress noises such as noise of wind and an extreme value by using an anomalous amplitude attenuation method, to increase a signal-to-noise ratio of seismic data, and obtain a seismic data set after noise suppression.

Step 5. perform, by using a surface-consistent amplitude compensation method, energy compensation on the seismic data set after noise suppression, to balance seismic wave energy recorded at different source points and receiver points, and obtain a seismic data set after surface-consistent amplitude compensation.

Step 6. based on the seismic data set after surface-consistent amplitude compensation, implement deconvolution comprehensively by using a combination of predictive deconvolution method and surface-consistent deconvolution method, to increase consistency of source signals and resolution of the seismic data, and obtain a seismic data set after deconvolution.

Step 7. based on the seismic data set after deconvolution, by using an iterative residual static correction method and a high-accuracy velocity analysis method, obtain a migration velocity model and a seismic data set after residual static correction.

Step 8. based on the migration velocity model and the seismic data set after residual static correction, perform migration and stacking processing by using a Kirchhoff pre-stack migration method, to obtain a migrated common reflection point gather and a stacked imaging data set based on stretching and muting.

Step 9. by using the migration velocity model generated in step 7, for the common reflection point gather obtained in step 8, by using an inverse normal move-out correction method, obtain a common reflection point gather after inverse normal move-out correction.

Step 10. manually mute direct waves and refracted waves on the common reflection point gather after inverse normal move-out correction, to obtain a common reflection point gather after muting.

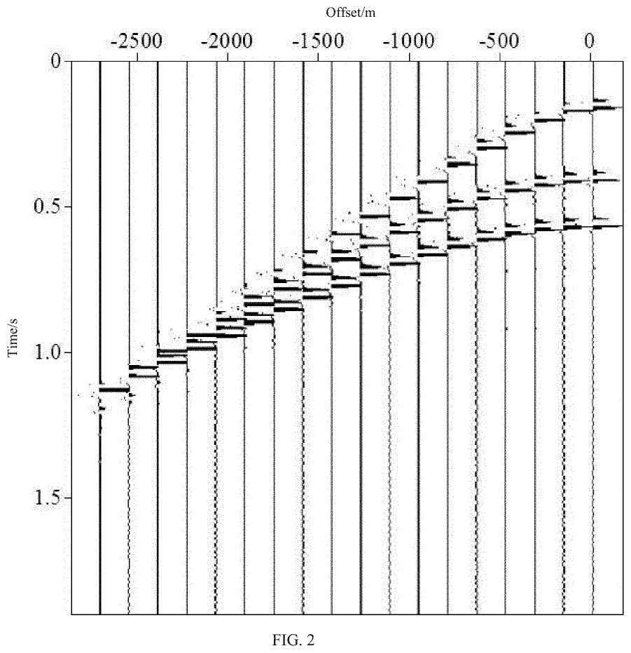

FIG. 2 shows a common reflection point gather obtained after processing according to step 1 to step 10. It can be seen from FIG. 2 that seismic reflected wave information from three layers of shallow geological interface varies with offset.

Step 11. based on the stacked imaging data set obtained in step 8, by using a window function having two to three wave lengths of a target formation, intercept seismic data including formation information on shallow target, to obtain zero-offset gathers at different reflection points.

Step 12. calculate the amount of move-out correction for each common reflection point gather based on cross-correlation between a seismic trace at different offset in each common reflection point gather obtained in step 10 and a corresponding zero-offset seismic trace obtained in step 11, where an obtaining formula thereof is as follows:

ΔT(X,ω)=R(X,ω)R*(X₀,ω),

where X represents the offset, X₀ represents the zero offset, ω represents angular frequency, * represents a complex conjugate, R(X, ω) represents a seismic trace at different offset, R*(X₀, ω) represents a complex conjugate of the zero-offset seismic trace, and ΔT(X, ω) represents the amount of move-out correction at different offset.

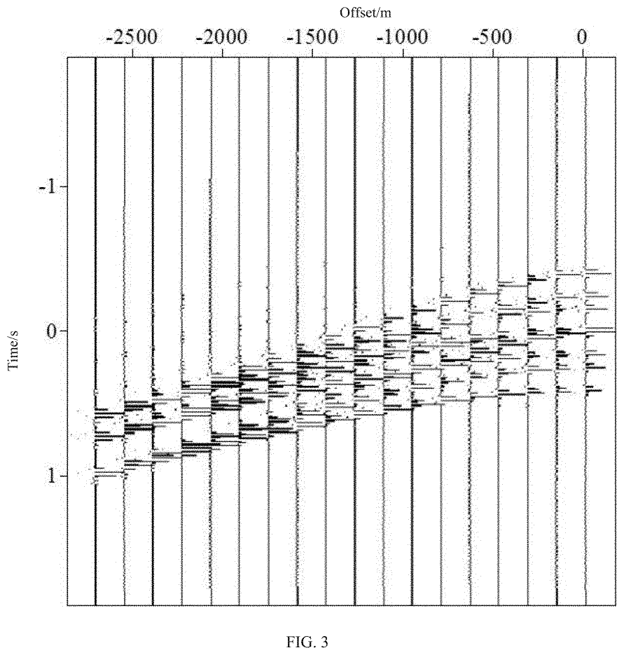

FIG. 3 shows the amount of move-out correction for different seismic traces in a common reflection point gather obtained according to step 12. It may be seen from FIG. 3 that, the reflection events with different curvatures passing a time zero is the amount of move-out correction obtained through cross-correlation and representing the amount of move-out correction corresponding to different reflection interfaces.

Step 13. obtain, through cross-correlation between a seismic trace at different offset in each common reflection point gather obtained in step 10 and the amount of move-out correction obtained in step 12, a common reflection point gather after interferometric normal move-out correction, where an obtaining formula thereof is as follows:

N(X,ω)=R(X,ω)ΔT*(X,ω),

where ΔT*(X, ω) represents the common conjugate of the amount of move-out correction obtained in step 11, and N(X, ω) represents a seismic trace at different offset after interferometric normal move-out.

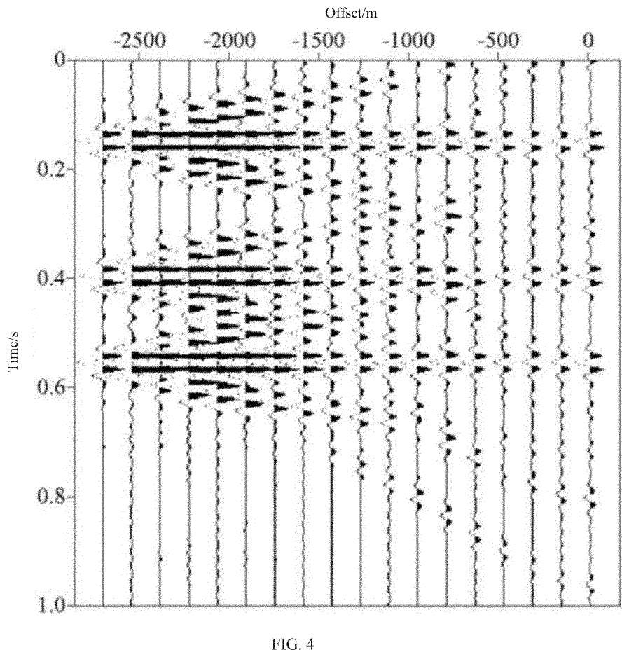

FIG. 4 shows a common reflection point gather after the amount of move-out correction is loaded according to step 13, and it can be seen from FIG. 4 that three effective reflection events from shallow formations have been reconstructed with high fidelity and same phase. In addition, due to the mutual interference of reflected wave fields from different formations, fake events with different phases are generated.

Step 14. obtain imaging results at different reflection points through focus-stacking on the common reflection point gather after interferometric normal move-out correction and that is obtained in step 13, where a focus-stacking imaging formula thereof is as follows:

$$S ( ω ) = {\sum }_{x} N ( X , ω ) , \qquad$$

where Σ represents the stacking summation, and S(ω) represents the focus-stacked imaging result at each reflection point.

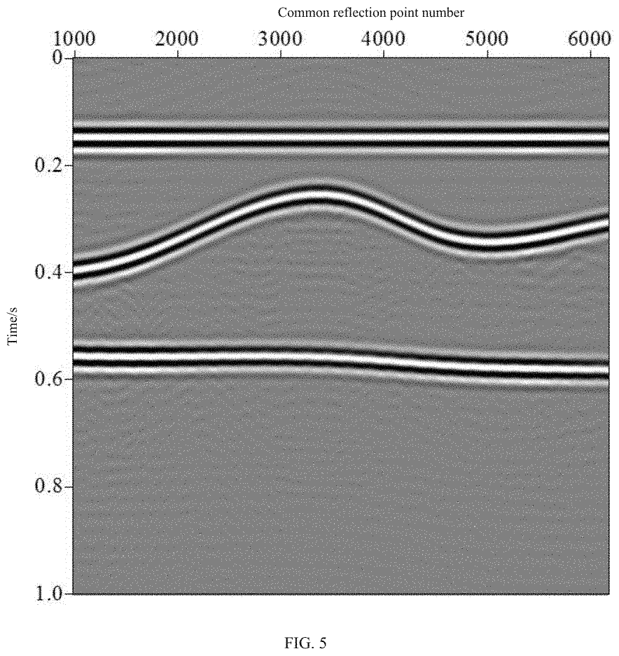

FIG. 5 shows an imaging result after focus-stacking is performed, and clear changes in tectonic characteristics of three layers of shallow geological interfaces can be seen in FIG. 5.

### Example 3

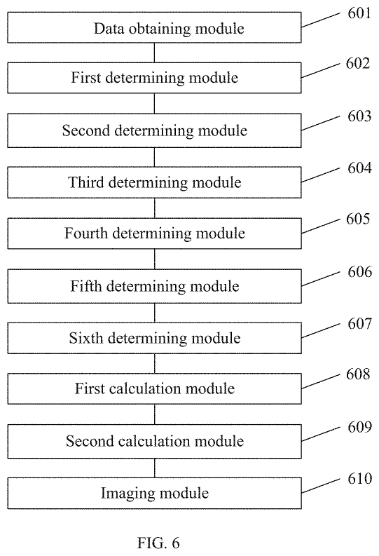

This example provides a focus-stacking imaging system based on correlation-based seismic interferometry. FIG. 6 is a schematic structural diagram of a focus-stacking imaging system based on correlation-based seismic interferometry according to Example 3 of the present invention.

Referring to FIG. 6, the focus-stacking imaging system based on correlation-based seismic interferometry in this example includes:

a data obtaining module 601, configured to obtain a seismic data set;

a first determining module 602, configured to load an acquisition system to the seismic data set, to obtain a seismic data set including acquisition system information;

a second determining module 603, configured to pick up, by using the seismic data set including the observing system information, seismic first arrival traveltimes recorded by all shot gathers, and sequentially perform refraction tomographic static correction based on seismic first arrival traveltimes, noise suppression, energy compensation, and deconvolution, to obtain a seismic data set after deconvolution;

a third determining module 604, configured to process the seismic data set after deconvolution by using an iterative residual static correction method and a high-accuracy velocity analysis method, to obtain a migration velocity model and a seismic data set after residual static correction;

a fourth determining module 605, configured to perform, based on the migration velocity model by using a Kirchhoff pre-stack migration method, migration and stacking processing on the seismic data set after residual static correction, to obtain a migrated common reflection point gather and a stacked imaging data set based on stretching and muting;

a fifth determining module 606, configured to process the migrated common reflection point gather sequentially by using a processing method of inverse normal move-out correction and a manual muting method based on the migration velocity model, to obtain a common reflection point gather after muting;

a sixth determining module 607, configured to intercept, by using a window function having a specified wave length, seismic data including formation information on shallow target in the stacked imaging data set based on stretching and muting, to obtain zero-offset gathers at different reflection points;

a first calculation module 608, configured to calculate cross-correlation between a seismic trace at different offset and a corresponding zero-offset seismic trace in the common reflection point gather after muting, to obtain an amount of move-out correction for each common reflection point gather;

a second calculation module 609, configured to calculate cross-correlation between a seismic trace at different offset in the common reflection point gather after muting and the amount of move-out correction, to obtain a common reflection point gather after interferometric normal move-out; and an imaging module 610, configured to perform focus-stacking on the common reflection point gather after interferometric normal move-out, to obtain imaging results at different reflection points.

In an optional implementation, the second determining module 603 specifically includes:

a first determining unit, configured to pick up, by using the seismic data set including the acquisition system information, the seismic first arrival traveltimes recorded by all the shot gathers, and obtain, by using a refraction tomographic static correction method, a seismic data set after refraction tomographic static correction;

a second determining unit, configured to perform noise suppression on the seismic data set after refraction tomographic static correction, to obtain a seismic data set after noise suppression;

a third determining unit, configured to perform, by using a surface-consistent amplitude compensation method, energy compensation on the seismic data set after noise suppression, to obtain a compensated seismic data set; and

a fourth determining unit, configured to deconvolute the compensated seismic data set by using a combination of predictive deconvolution method and surface-consistent deconvolution method, to obtain a seismic data set after deconvolution.

In an optional implementation, the fifth determining module 606 specifically includes:

a fifth determining unit, configured to process the migrated common reflection point gather by using the processing method of inverse normal move-out correction based on the migration velocity model, to obtain a common reflection point gather after inverse normal move-out correction; and

a sixth determining unit, configured to manually mute direct waves and refracted waves on the common reflection point gather after inverse normal move-out correction, to obtain the common reflection point gather after muting.

In an optional implementation, the data obtaining module 601 specifically includes:

a raw data obtaining unit, configured to obtain raw seismic data; and

an abnormal data deletion unit, configured to delete an abnormal data set in the raw seismic data, to obtain the seismic data set, where the abnormal data set includes bad shots, environmental noise shots, and seismic data with dead traces.

In an optional implementation, the second determining unit specifically includes:

a noise suppression subunit, configured to suppress, sequentially by using an adaptive surface wave attenuation method, a linear correlation method, and an anomalous amplitude attenuation method, noises of the seismic data set after refraction tomographic static correction, to obtain a seismic data set after noise suppression.

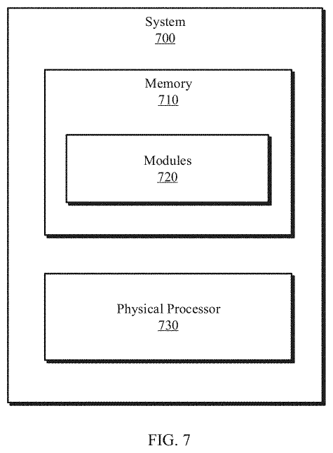

FIG. 7 is a block diagram of an example system 700 capable of performing the methods disclosed herein. As illustrated in FIG. 7, example system 700 may include one or more memory devices, such as memory 710. Memory 710 generally represents any type or form of volatile or non-volatile storage device or medium capable of storing data and/or computer-readable instructions. In one example, memory 710 may store, load, and/or maintain one or more of modules 720. Examples of memory 710 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in this figure, example system 700 may include one or more modules 720 for performing one or more tasks. As will be explained in greater detail below, modules 720 may represent one or more of the modules disclosed herein (e.g., the modules shown in FIG. 6). Although illustrated as separate elements, one or more of modules 720 in FIG. 7 may represent portions of a single module or application.

In certain embodiments, one or more of modules 720 in FIG. 7 may represent one or more software applications or programs that, when executed by a computing device, may cause the computing device to perform one or more tasks. One or more of modules 720 in FIG. 7 may also represent all or portions of one or more special-purpose computers configured to perform one or more tasks.

As illustrated in FIG. 7, example system 700 may also include one or more physical processors, such as physical processor 730. Physical processor 730 generally represents any type or form of hardware-implemented processing unit capable of interpreting and/or executing computer-readable instructions. In one example, physical processor 730 may access and/or modify one or more of modules 720 stored in memory 710. Additionally or alternatively, physical processor 730 may execute one or more of modules 720 to facilitate performing the methods described herein. Examples of physical processor 730 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor. Although illustrated as separate elements, the modules described and/or illustrated herein may represent portions of a single module, application, and/or computer-readable medium. In addition, in certain embodiments one or more of these modules may represent one or more software applications or programs that, when executed by a computing device, may cause the computing device to perform one or more tasks. For example, one or more of the modules described and/or illustrated herein may represent modules stored and configured on any suitable computing system. One or more of these modules may represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Each example of the present specification is described in a progressive manner, each example focuses on the difference from other examples, and the same and similar parts between the examples may refer to each other. For a system disclosed in the examples, since the system corresponds to the method disclosed in the examples, the description is relatively simple, and reference can be made to the method description.

In this specification, several specific examples are used for illustration of the principles and implementations of the present invention. The description of the foregoing examples is used to help illustrate the method of the present invention and the core ideas thereof. In addition, those of ordinary skill in the art can make various modifications in terms of specific implementations and scope of application in accordance with the ideas of the present invention. In conclusion, the content of this specification shall not be construed as a limitation to the present invention.

What is claimed is:

1. A computer-implemented focus-stacking imaging method based on correlation-based seismic interferometry, at least a portion of the method being performed by a computing device, the method comprising:
obtaining a seismic data set;
loading an acquisition system to the seismic data set, to obtain a seismic data set comprising acquisition system information;
picking up, by using the seismic data set comprising the acquisition system information, seismic first arrival traveltimes recorded by all shot gathers, and sequentially performing refraction tomographic static correction based on the seismic first arrival traveltimes, noise suppression, energy compensation, and deconvolution, to obtain a seismic data set after deconvolution;
processing the seismic data set after deconvolution by using an iterative residual static correction method and a high-accuracy velocity analysis method, to obtain a migration velocity model and a seismic data set after residual static correction;
performing, based on the migration velocity model by using a Kirchhoff pre-stack migration method, migration and stacking processing on the seismic data set after the residual static correction, to obtain a migrated common reflection point gather and a stacked imaging data set based on stretching and muting;
processing the migrated common reflection point gather sequentially by using a processing method of inverse normal move-out correction and a manual muting method based on the migration velocity model, to obtain a common reflection point gather after muting;
intercepting, by using a window function having a specified wave length, seismic data comprising formation information on shallow target in the stacked imaging data set based on stretching and muting, to obtain zero-offset gathers at different reflection points;
calculating cross-correlation between a seismic trace at different offset and a corresponding zero-offset seismic trace in the common reflection point gather after muting, to obtain an amount of move-out correction for each common reflection point gather;
calculating cross-correlation between a seismic trace at different offset in the common reflection point gather after muting and the amount of move-out correction, to obtain a common reflection point gather after interferometric normal move-out correction; and
performing focus-stacking on the common reflection point gather after interferometric normal move-out correction, to obtain imaging results at different reflection points.

2. The focus-stacking imaging method based on correlation-based seismic interferometry according to claim 1, wherein the picking up, by using the seismic data set comprising the acquisition system information, seismic first arrival traveltimes recorded by all shot gathers, and sequentially performing refraction tomographic static correction based on seismic first arrival traveltimes, noise suppression, energy compensation, and deconvolution, to obtain a seismic data set after deconvolution specifically comprises:
picking up, by using the seismic data set comprising the acquisition system information, seismic first arrival traveltimes recorded by all shot gathers, and obtaining, by using a refraction tomographic static correction method, a seismic data set after refraction tomographic static correction;
performing noise suppression on the seismic data set after refraction tomographic static correction, to obtain a seismic data set after noise suppression;
performing, by using a surface-consistent amplitude compensation method, energy compensation on the seismic data set after noise suppression, to obtain a compensated seismic data set; and
deconvoluting the compensated seismic data set by using a combination of predictive deconvolution method and surface-consistent deconvolution method, to obtain a seismic data set after deconvolution.

3. The focus-stacking imaging method based on correlation-based seismic interferometry according to claim 1, wherein the processing the migrated common reflection point gather sequentially by using a processing method of inverse normal move-out correction and a manual muting method based on the migration velocity model, to obtain a common reflection point gather after muting specifically comprises:
processing the migrated common reflection point gather by using the processing method of inverse normal move-out correction based on the migration velocity model, to obtain a common reflection point gather after inverse normal move-out correction; and
manually muting direct waves and refracted waves on the common reflection point gather after inverse normal move-out correction, to obtain the common reflection point gather after muting.

4. The focus-stacking imaging method based on correlation-based seismic interferometry according to claim 1, wherein the obtaining a seismic data set specifically comprises:
obtaining raw seismic data; and
deleting an abnormal data set in the raw seismic data, to obtain the seismic data set, wherein the abnormal data set comprises bad shots, environmental noise shots, and seismic data with dead traces.

5. The focus-stacking imaging method based on correlation-based seismic interferometry according to claim 2, wherein the performing noise suppression on the seismic data set after refraction tomographic static correction, to obtain a seismic data set after noise suppression specifically comprises:
suppressing, sequentially by using an adaptive surface wave attenuation method, a linear correlation method, and an anomalous amplitude attenuation method, noise of the seismic data set after refraction tomographic static correction, to obtain a seismic data set after noise suppression.

6. A focus-stacking imaging system based on correlation-based seismic interferometry, comprising:
a data obtaining module, configured to obtain a seismic data set;
a first determining module, configured to load an acquisition system to the seismic data set, to obtain a seismic data set comprising acquisition system information;
a second determining module, configured to pick up, by using the seismic data set comprising the acquisition system information, seismic first arrival traveltimes recorded by all shot gathers, and sequentially perform refraction tomographic static correction based on seismic first arrival traveltimes, noise suppression, energy compensation, and deconvolution, to obtain a seismic data set after deconvolution;
a third determining module, configured to process the seismic data set after deconvolution by using an iterative residual static correction method and a high-accuracy velocity analysis method, to obtain a migration velocity model and a seismic data set after residual static correction;
a fourth determining module, configured to perform, based on the migration velocity model by using a Kirchhoff pre-stack migration method, migration and stacking processing on the seismic data set after the residual static correction, to obtain a migrated common reflection point gather and a stacked imaging data set based on stretching and muting;
a fifth determining module, configured to process the migrated common reflection point gather sequentially by using a processing method of inverse normal move-out correction and a manual muting method based on the migration velocity model, to obtain a common reflection point gather after muting;
a sixth determining module, configured to intercept, by using a window function having a specified wave length, seismic data comprising formation information on shallow target in the stacked imaging data set based on stretching and muting, to obtain zero-offset gathers at different reflection points;
a first calculation module, configured to calculate cross-correlation between a seismic trace at different offset and a corresponding zero-offset seismic trace in the common reflection point gather after muting, to obtain an amount of move-out correction for each common reflection point gather;
a second calculation module, configured to calculate cross-correlation between a seismic trace at different offset in the common reflection point gather after muting and the amount of move-out correction, to obtain a common reflection point gather after interferometric normal move-out correction;
an imaging module, configured to perform focus-stacking on the common reflection point gather after interferometric normal move-out correction, to obtain imaging results at different reflection points; and
at least one physical processor configured to execute the data obtaining module, the first determining module, the second determining module, the third determining module, the fourth determining module, the fifth determining module, the sixth determining module, the first calculation module, the second calculation module, and the imaging module.

7. The focus-stacking imaging system based on correlation-based seismic interferometry according to claim 6, wherein the second determining module specifically comprises:
a first determining unit, configured to pick up, by using the seismic data set comprising the acquisition system information, seismic first arrival traveltimes recorded by all shot gathers, and obtain, by using a refraction tomographic static correction method, a seismic data set after refraction tomographic static correction;
a second determining unit, configured to perform noise suppression on the seismic data set after refraction tomographic static correction, to obtain a seismic data set after noise suppression;
a third determining unit, configured to perform, by using a surface-consistent amplitude compensation method, energy compensation on the seismic data set after noise suppression, to obtain a compensated seismic data set; and
a fourth determining unit, configured to deconvolute the compensated seismic data set by using a combination of predictive deconvolution method and surface-consistent deconvolution method, to obtain a seismic data set after deconvolution.

8. The focus-stacking imaging system based on correlation-based seismic interferometry according to claim 6, wherein the fifth determining module specifically comprises:
a fifth determining unit, configured to process the migrated common reflection point gather by using a processing method of inverse normal move-out correction based on the migration velocity model, to obtain a common reflection point gather after inverse normal move-out correction; and
a sixth determining unit, configured to manually mute direct waves and refracted waves on the common reflection point gather after inverse normal move-out correction, to obtain the common reflection point gather after muting.

9. The focus-stacking imaging system based on correlation-based seismic interferometry according to claim 6, wherein the data obtaining module specifically comprises:
a raw data obtaining unit, configured to obtain raw seismic data; and
an abnormal data deletion unit, configured to delete an abnormal data set in the raw seismic data, to obtain the seismic data set, wherein the abnormal data set include bad shots, environmental noise shots, and seismic data with dead traces.

10. The focus-stacking imaging system based on correlation-based seismic interferometry according to claim 7, wherein the second determining module specifically comprises:
a noise suppression subunit, configured to suppress, sequentially by using an adaptive surface wave attenuation method, a linear correlation method, and an anomalous amplitude attenuation method, noises of the seismic data set after refraction tomographic static correction, to obtain a seismic data set after noise suppression.
